(19) United States
(12) Patent Application Publication
(10) Pub. No.: US 2008/0224343 A1
(43) Pub. Date: Sep. 18, 2008

(54) OPEN CERAMIC MEDIA STRUCTURE AND METHOD OF MANUFACTURING

(76) Inventors: Donald W. Baldwin, Perrysburg, OH (US); Bradley R. Postage, Simpsonville, SC (US); Philip P. Treier, Bloomdale, OH (US)

Correspondence Address: Honeywell International Inc.;Law Department Patent Services, P.O. Box 2245, Morristown, NJ, 07962, US

(21) Appl. No.: 12/048,984

(22) Filed: Mar. 14, 2008

Related U.S. Application Data
(60) Provisional application No. 60/895,219, filed on Mar. 16, 2007.

(51) Int. Cl. B29C 44/12

(52) U.S. Cl. 264/45.3

(57) ABSTRACT

A method of producing a porous ceramic media structure is provided. The method comprises preparing an aqueous solution that comprises ceramic fibers in a liquid carrier, adding a pore-forming, fibrous material to the aqueous solution, drying the aqueous solution to form a ceramic web, and removing the fibrous material from the ceramic web to thereby increase the porosity of the ceramic web.

### CROSS REFERENCE TO RELATED APPLICATION

This application claims the benefit of U.S. Patent Application Ser. No. 60/895,219, filed Mar. 16, 2007, the contents of which are incorporated herein by reference thereto.

### BACKGROUND

Exemplary embodiments of the present invention relate to a method for preparing ceramic filter media and ceramic filter media prepared by the same. More particularly, exemplary embodiments of the present invention relate to a method for preparing ceramic filter media a high degree of porosity, and high-porosity ceramic filter media prepared by the same.

Because diesel automobile engines are known to have higher energy efficiency and lower carbon monoxide and hydrocarbon discharge than gasoline engines, their use has increased in recent years. Diesel engines, however, have become the target of criticism because of air pollution resulting from particulate matters (PM) produced by its exhaust gas. As many regulatory agencies have recently mandated the reduction of PM emissions in diesel engines, there has been increased activity in the development of exhaust gas filters for diesel engines. A typical exhaust filter will trap the particulate material contained in the exhaust stream, and then, to prevent clogging of the filter and the resultant increase of load on the engine due to increased backpressure, burn the particulate material from the filter.

One such apparatus for used filtering PM in exhaust gas from diesel engines is the diesel particulate filter (DPF). A DPF should be able to trap particulates included in exhaust gas, and reduce or eliminate the particulates before the build-up of PM in the filter results in a pressure drop that can adversely affect the engine. Also, an effective DPF should be durable and have high temperature resistance.

DPFs can be classified into three types: honeycomb monolith filters, ceramic fiber filters, and metal filters. Among these, the honeycomb monolith filter is the most vulnerable to the effects of high temperatures, and thus has the shortest lifecycle. The metal filter provides the advantage of simple and low cost production, but also has the disadvantages of poor resistance to heat and mechanical wear. Because of the disadvantages of honeycomb monolith filter and metal filters, diesel engine manufacturers have turned their attention to ceramic fiber filters.

Generally, the following three characteristics are important in determining the overall filtering function or capability of a porous ceramic fiber filter: a) trapping efficiency (that is, the ratio of PM removed from a subject fluid, to PM not removed); b) pressure loss (that is, the amount of pressure drop of the subject fluid flowing through the filter); and c) nominal operation time (that is, the time duration from the commencement of use of the filter to the time at which the pressure loss increases to an upper limit). In this respect, it is significant to note that the trapping efficiency is proportional to the pressure loss. Namely, an increase in the trapping efficiency results in an undesirable increase in the pressure loss, and a consequent decrease in the operation time. If the filter is adapted for a comparatively reduced amount of pressure loss, the operation time can be prolonged, but the trapping efficiency is unfavourably lowered.

Ceramic fiber filters are manufactured in the form of foams, extruded articles, and non-woven media. Of these, the non-woven paper form is known to have the highest porosity rate, and therefore the highest efficiency for eliminating particulates. Moreover, the foam and extruded article forms are more vulnerable to heat impact, and the extruded form has a particularly low porosity rate, thus providing poor exhaust gas permeability.

Nonwoven filters comprising ceramic fiber should provide a mechanical strength that is sufficient to withstand the vibration of automobile, a porosity that is high enough to keep the backpressure caused by PM sufficiently low, and uniform dispersion of enough pores to raise the filtering efficiency of micro- and nano-sized particles.

The most important characteristic of a ceramic filter is the trapping time, that is, the time duration for which the filter can operate with the pressure loss held below the permissible upper limit. For the reasons described above, however, it has been considered difficult to increase the trapping time while maintaining a sufficiently high trapping efficiency. In this respect, it is noted that an increase in the nominal operation time of a ceramic filter results in a decrease in the required volume of the filter for a specific application, and the decrease in the required volume contributes to an improvement in the thermal shock or stress resistance of the filter. Therefore, it is desirable to increase the operation time (life expectancy) of the filter, particularly where the contaminated or clogged filter can be reclaimed by burning out the contaminants or particulate matters, as in the case of a DPF used for a diesel engine. In particular, the operation time, as well as the filtering performance, will increase as the degree of porosity and the mean pore size of the final ceramic filter media increases.

Accordingly, there is a need to provide a method for preparing a ceramic filter media having good mechanical strength and a large mean pore size and porosity that can provide for excellent exhaust gas permeability, and to provide high-porosity ceramic filter media prepared by the same.

### SUMMARY OF THE INVENTION

Exemplary embodiments of the present invention provide a method of producing a porous ceramic media structure. The method comprises preparing an aqueous solution that comprises ceramic fibers in a liquid carrier, adding a pore-forming, fibrous material to the aqueous solution, drying the aqueous solution to form a ceramic web, and removing the fibrous material from the ceramic web to thereby increase the porosity of the ceramic web.

Exemplary embodiments of the present invention also provide a second method of producing a porous ceramic media structure. The method comprises preparing an aqueous solution that comprises ceramic fibers in a liquid carrier, drying the aqueous solution to form a ceramic web, embedding a surface of the ceramic web with a first amount of a pore-forming, fibrous material, and removing the first amount of the fibrous material from the surface of the ceramic web to thereby increase topographical porosity of the ceramic web.

Exemplary embodiments of the present invention also provide a third method of producing a porous ceramic media structure. The method comprises preparing an aqueous solution that comprises ceramic fibers in a liquid carrier, adding a three-dimensional fibrous material to the aqueous solution, drying the aqueous solution to form a ceramic web, and removing the three-dimensional fibrous material from the ceramic web to thereby increase the porosity of the ceramic web.

### DETAILED DESCRIPTION OF EXEMPLARY EMBODIMENTS

In accordance with the present invention, an exemplary embodiment of a method for preparing nonwoven ceramic filter media is provided. The method can comprise the steps involved in the manufacture of ceramic filter media by any conventional or known papermaking method. In a typical process, an aqueous or solvent dispersion of ceramic fibers and other components is initially prepared in a solution mixer or blender. In the present exemplary embodiment, the slurry that is prepared also includes fibrous sacrificial components, the addition of which will serve to alter the morphological structure of the nonwoven ceramic filter media formed by the process, as will be described below. More particularly, the fibrous sacrificial components will be physically or chemically removed at a later processing step, which will have the affect of increasing the porosity of the final media structure. The other components of the slurry may include inorganic and/or organic binders, a liquid carrier (preferably water), and optional materials including organic fibers, surfactants, clays, defoamers, and other particulate materials. The exact parameters for the papermaking process in specific exemplary embodiments can be determined experimentally.

In the present exemplary embodiment, the pulp slurry is sheared with a blender for 30 to 90 seconds to produce a uniform mixture of the ceramic and organic fibers in the slurry prior to papermaking. Organic fibers and binders, such as a latex binder, are preferably included to impart flexibility and handling strength to the sheet. A coagulating agent can also be added to the slurry to coagulate organic and/or inorganic binders and cause attachment of the organic and/or inorganic binders to the ceramic and organic fibers. Immediately after coagulation, the slurry is wet laid onto a fine screen or felt. The water or solvent is removed by, for example, pressing or vacuuming, to leave a sheet of entangled fibers and binders.

The ceramic fibers used in the present exemplary embodiment can be formed using refractory materials that can withstand high temperatures of at least 1200 degrees Celsius including, for example, metal oxides, metal nitrides, metal carbides or combinations thereof. For example, the ceramic fiber can comprise fibers formed from metal oxides which include alumina, alumina-silica, alumina-boria-silica, silica, zirconia, zirconia-silica, titania, titania-silica, rare earth oxides, and combinations thereof. In one exemplary embodiment, silicon carbide fibers are used because they can provide excellent mechanical strength, heat resistance, and chemical stability. At least some or all of the ceramic fibers included in the slurry can be at least partially coated with or at least partially contain oxidation catalyst materials. In addition, the ceramic fibers can be at least partially coated with such a catalyst material after the fibers are disposed in web form. The ceramic fibers in the paper can also comprise catalyst material(s). Such catalyst materials can include, for example, ceria; ceria-zirconia; first transition series oxides; perovskites, such as titanates and rare earth cobalt or manganese oxides; and other materials known to be active oxidation catalysts for the oxidation of diesel soot.

In exemplary embodiments, the ceramic fiber can have a diameter of 1-25 microns and a length of 0.1-10 millimeters. In exemplary embodiments, the ceramic fiber can have a length of 0.1-1 millimeters to ensure a sufficient mechanical strength of the paper prepared and a uniform dispersement of the fibers. The amount of ceramic fiber in the slurry solution can be 50-80 percent by weight, as compared to the total amount of solid contents in the slurry solution, to ensure a consistent media shape and uniform porosity. Ceramic fibers of different lengths, diameters, and compositions can be advantageously blended to also produce high strength, uniform media structures.

In the present exemplary embodiment, the slurry solution used to make the ceramic media may further comprise organic materials such as, for example, organic fibers. Suitable organic fibers can include, for example, those formed from acrylic, rayon, cellulose, polyester, nylon, Kevlar, and combinations thereof. In exemplary embodiments, cellulose fibers and/or fibrillated synthetic organic fibers are included in a combined total amount in the range of from about 10 percent to about 15 percent by weight of the solids in the slurry. Cellulose fibers include, for example, long-length northern softwood fibers or synthetic cellulose fibers. Fibrillated organic fibers include, for example, fibrillated Kevlar fibers (E. I. du Pont de Nemours and Company, Wilmington, Del.) and fibrillated polyolefin fibers such as Fybrel (Mitsui Chemicals America, Incorporated, Purchase, N.Y.). Cellulose fibers are capable of hydrogen bonding and the addition of these fibers can improve the wet web strength of the ceramic media as it is formed on the papermaking machine. The fibrillated fibers, which can a diameter similar to the ceramic fibers in exemplary embodiments, provide added mechanical integrity to the paper. The fibrillated fibers typically have a kinked structure, which causes the fibrillated fibers to become mechanically entangled with the ceramic fibers, significantly increasing the resistance of the media to cutting or tearing. The additional structural integrity resulting from the use of fibrillated fibers is believed to enable the sheet to be folded or pleated while maintaining the integrity of the fiber media. Additionally, the high temperature resistance of Kevlar can allow the media to maintain its integrity at higher temperatures and thereby allow the curing of additional inorganic binders.

Moreover, the slurry solution may also comprise a small amount of organic binder to impart flexibility and handling strength to the ceramic media. The organic binder can be a latex, thermoplastic fibers, or a combination thereof. Suitable organic binders that may be included in the slurry solution can be one of many that are conventionally for such purposes, such as, for example, one or more selected from the group consisting of methyl cellulose, hydroxyethyl cellulose, sodium carboxymethyl cellulose, purified starch, dextrin, polyvinyl alcohol, polyvinyl butyral, polymethylmethacrylate, polyethylene glycol, paraffin, wax emulsion, microcrystalline wax, and mixtures thereof. The organic binder imparts a degree of thermoplastic character to the ceramic fiber media. Such thermoplasticity can provide for convenient forming (for example, thermoforming) of pleats, creases and bends in the ceramic media without breakage, and to retain the shape of the formed articles after forming. In exemplary embodiments, the amount of the organic binder can be 5-20 parts by weight to 100 parts by weight of the ceramic fiber to ensure proper bonding of the fibers and maintain a proper viscosity level.

In exemplary embodiments, the slurry solution may further comprise inorganic binder material such as, for example, ceramic precursors, ceramic particles (for example, powders, fiber segments, flakes, etc.), or both, to provide additional strength to the ceramic media and/or to alter the pore structure of the media. Ceramic precursors are, generally, materials that will form a high temperature ceramic after being fired. Suitable ceramic precursors include, for example, metal oxy-hydroxides, low solubility metal salts, and low solubility metal complexes that are low in alkali metal content. Suitable ceramic particles include powder of, for example, metal oxides, metal nitrides, metal borides, and metal carbides. Representative examples of ceramic precursors that may be suitable include boehmite (aluminum oxy-hydroxide), hydrated clays, aluminum tri-hydrate, iron oxy-hydroxide, and oxalate complexes such as calcium oxalate, magnesium oxalate, copper oxalate, and rare earth oxalate. Representative examples of ceramic particles that may be suitable include powders of aluminas, alumino-silicates, silicon carbide, silicon nitride, silica, titanium nitride, titanium boride, boron nitride, zirconia, ceria, iron oxide, magnesia, rare earth oxides and aluminates, barium aluminate, calcium aluminate, zirconium phosphate, and rare earth phosphates. Certain of these additives may be used to introduce catalytic activity or microwave receptivity to the resulting ceramic fiber media. For example, metal carbides (for example, silicon carbide) can be used to introduce microwave receptivity. In additional examples, a ceria-zirconia alloy and iron oxide can be used to introduce catalytic activity. In exemplary embodiments, these ceramic precursors and ceramic particles can be added in amounts up to about 30 percent, and possibly up to about 40 percent, by weight of the ceramic solids in the slurry solution.

The slurry solution may further comprise chemical agents such as, for example, a pH-level controlling agent that can lower pH-level to thereby increase the adhesiveness of the organic binder to the ceramic fiber or the organic fiber. In exemplary embodiments, such a pH-level controlling agent can be one of many that are conventionally used for such purposes. For example, the pH-level of the slurry solution may be maintained between 5.5 and 6.5, if so desired, by using ammonium aluminum sulfate (alum). Other chemical agents that can be useful include polyanionic complexes, anionic and cationic polymers, and other metal salts or complexes known to form polynuclear cationic species in solution.

The amount of water used in the slurry is not critical and, in exemplary embodiments, can be such that it provides the slurry with a consistency where it can be readily fed from a conventional headbox of a papermaking machine onto a porous moving belt or support in a conventional manner to provide a thin sheet or web. The sheet can be vacuum dried on the porous belt and then subsequently heat dried to remove the remaining water or carrier. The resulting dried sheet consists of haphazardly arranged ceramic and organic fibers bonded by the organic binder. The dried sheet or web is flexible and can then be formed into any desired three-dimensional article suitable for a filter.

In the present exemplary embodiment, incorporating either sacrificial fibers or sacrificial spheres into the slurries from which the sheets of ceramic fiber media are formed can vary the porosity distribution of the sheets that are formed. The sacrificial fibers or sacrificial spheres blended with the slurry can be comprised of, for example, synthetic fibers, cellulose fibers, metallic materials having a low-melting point, and combinations thereof, which are subsequently removed from the ceramic media to leave open microchannels within the media. Synthetic fibers used in exemplary embodiments can include, for example, rayons, acetates, nylons, modacrylics, olefins, acrylics, polyesters such as polyethylene terephthalate, PLAs, or combinations thereof. Metallic fibers used in exemplary embodiments can be comprised of metal, plastic-coated metal, metal-coated plastic, or a core completely covered by metal, and can include, for example, zinc yars, magnesium yarns, aluminum yarns, aluminized plastic yarns, aluminized nylon yarns, and combinations thereof.

By uniformly dispersing the fibrous sacrificial components into the slurry solution prior to feeding the slurry through the papermaking machine, morphological changes can be brought about during processing by heat-treating the media at a high temperature following the drying step to leave pores in the ceramic fiber media and thereby increase the structural porosity of the final media structure following the papermaking process. The distribution of the sacrificial materials and the nature of those sacrificial materials (such as spheres or fibers) will determine the distribution and the nature of the porosity. For example, in designing the slurries, the proportions and nature of the sacrificial materials can be chosen in such a fashion that the final products could either have an interconnecting network of porosity, an isolated non-interconnected porosity, or both. The pore or channel size, which is primarily determined by the diameter of the sacrificial fibers and/or spheres, can vary in a range from 1 to 100 microns.

Prior to drying, the slurries can comprise composite layers containing varying degrees of the sacrificial organic fibers and spheres. Following drying to remove the liquid carrier, the sacrificial materials may be removed, for example, by heat-treating the ceramic sheets at temperatures sufficient to thermally decompose or burn away the sacrificial fibers or spheres. For example, temperatures of 700-900 degrees Celsius are typically sufficient for removal. The heat-treating process can involve, for example, placing the ceramic sheets in a furnace, gradually increasing the temperature of the furnace to avoid any cracking of the ceramic sheet due to stress, and then holding the furnace at the desired heat-treating temperature burn off the sacrificial members and leaving a web of porous ceramic media. Following the heat-treatment, the temperature can be gradually brought back down to room temperature. Alternatively, the sacrificial materials may be removed to form a highly porous structure by placing the dried sheets in a solution to dissolve or chemically extract the sacrificial fibers or spheres.

In the present exemplary embodiment, the removal of the sacrificial members will leave voids in the dried ceramic sheets at the sites originally occupied by the sacrificial members, without a substantial detrimental effect on the resulting ceramic media. That is, the removal of sacrificial fibers results in the formation of embedded pores or voids in the form of microchannels, which are imprints of the portions of the sacrificial fibers that were embedded. This removal process can be utilized to obtain a porous ceramic fiber media having pores of a desired size and shape, and a variable degree of porosity controlled throughout all or substantially all of its thickness, which can then be wound into rolls for further processing. Porous ceramic filter media produced according the present exemplary method can be incorporated into a filter to reduce the pressure loss during the deposition of particulate matter within the filter and enable a high filtering efficiency.

In exemplary embodiments, the sacrificial components can, rather than or in addition to being incorporated within the initial slurry solution, be coated to the surface of the ceramic media during a later processing step to provide for the formation of a unique surface topography in the final nonwoven ceramic media. More specifically, the sacrificial components can be added after the slurry is fed onto the porous moving belt of the papermaking machine. The process for the coating the web with sacrificial components is not particularly limited and can be carried out by, for example, impregnation, spraying, or the like. Thus, after the sheet is vacuum dried on the porous belt and then subsequently heat dried to remove the remaining water or carrier, the resulting dried sheet consists of haphazardly arranged ceramic and organic fibers bonded by the organic binder, as well as sacrificial fibers or spheres partially embedded in the surface. The removal of the sacrificial elements from the surface of the sheet can be done by chemical or thermal means as described above to form surface voids or pores on the ceramic media that correspond to imprints of the portions of the sacrificial members that were embedded. These surface pores serve to increase the surface area of the ceramic fiber media, thereby increasing the media's gas permeability.

Exemplary embodiments of filters employing the porous ceramic fiber media prepared as described above, with at least some of the pores formed from sacrificial components being disposed on the surface so that the media has a nonuniform topography, can be very effectively used to collect and eliminate particulate matter from automobile exhaust gas. That is, because at least some of the pores are openly exposed, thereby increasing the surface area of the filter media, the deposition thickness as particulate matter adheres to the surface is reduced, thereby resulting in a corresponding suppression of pressure loss and enabling the efficient filtering and removal of particulate matter over an extended period of time.

In accordance with an exemplary embodiment of the present invention, nonwoven ceramic media prepared from a slurry as described above can also be formed with a high degree of porosity by incorporating a plurality of three-dimensional fibers. The three-dimensional fibers can be randomly or uniformly arranged into the sheet or web during the papermaking process. Suitable three-dimensional fiber shapes can include a variety of shapes ranging from simple round or oval cross-sectional areas to more complex trilobe, figure eight, star shaped, rectangular cross-sectional areas, or the like. Curved, crimped, spiral-shaped, branched, and other three-dimensional fiber geometries may be used. Likewise, the fibers may be hooked on one or both ends

The nonwoven ceramic media formed according to the present exemplary embodiment will thus have a construction comprising a three-dimensionally formed fibrous web and a ceramic mass filling the interstices between the component fibers of the fibrous web to give rise to a matrix. The three-dimensional fibrous web will have component fibers densely and cubically interwoven so that the individual fibers thereof strongly contact one another and form narrow interstices. In this case, the use of an organic binder in the slurry, as described above in relation to the prior exemplary embodiments, will induce thermal decomposition during a heat-treating step following removal of the liquid carrier by drying, thereby giving rise to many pores in the dried sheet or web. In exemplary embodiments, the temperature during such a heat-treating step can be in the range of 600-1000 degrees Celsius. Following the heat-treatment process, the nonwoven ceramic media that is formed will posses a large number of pores and a very high degree of porosity.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A method of producing a porous ceramic media structure, the method comprising:
preparing an aqueous solution that comprises ceramic fibers in a liquid carrier;
adding a pore-forming, fibrous material to the aqueous solution;
drying the aqueous solution to form a ceramic web; and
removing the fibrous material from the ceramic web to thereby increase the porosity of the ceramic web.

2. The method of claim 1, wherein the fibrous material is removed from the ceramic web of media by thermally decomposing the fibrous material from the ceramic web.

3. The method of claim 1, wherein the fibrous material is removed from the ceramic web of media by chemically extracting the fibrous material from the ceramic web.

4. A method of producing a porous ceramic media structure, the method comprising:
preparing an aqueous solution that comprises ceramic fibers in a liquid carrier;
drying the aqueous solution to form a ceramic web;
embedding a surface of the ceramic web with a first amount of a pore-forming, fibrous material; and
removing the first amount of the fibrous material from the surface of the ceramic web to thereby increase topographical porosity of the ceramic web.

5. The method of claim 4, further comprising adding a second amount of the pore-forming, fibrous material to the aqueous solution, wherein the second amount of the fibrous material is removed to thereby increase the porosity of the ceramic web when the first amount of the fibrous material is removed.

6. A method of producing a porous ceramic media structure, the method comprising:
preparing an aqueous solution that comprises ceramic fibers in a liquid carrier;
adding a three-dimensional fibrous material to the aqueous solution;
drying the aqueous solution to form a ceramic web; and
removing the three-dimensional fibrous material from the ceramic web to thereby increase the porosity of the ceramic web.

7. The method of claim 6, further comprising adding a first amount of a pore-forming, fibrous material to the aqueous solution, wherein the first amount of the fibrous material is removed from the ceramic web to thereby increase the porosity of the ceramic web.

8. The method of claim 7, further comprising embedding a surface of the ceramic web with a second amount of the pore-forming, fibrous material, wherein the second amount of the fibrous material is removed to thereby increase topographical porosity of the ceramic web when the first amount of the fibrous material is removed.
